(19) United States
(12) Patent Application Publication
(10) Pub. No.: US 2007/0145067 A1
(43) Pub. Date: Jun. 28, 2007

(54) Smoothie dispenser

(76) Inventor: Arthur Headlee, Port St. Lucie, FL (US)

Correspondence Address: MCHALE & SLAVIN, P.A., 2855 PGA BLVD, PALM BEACH GARDENS, FL, 33410, US

(21) Appl. No.: 11/317,749

(22) Filed: Dec. 23, 2005

(51) Int. Cl. G01F 11/00

(52) U.S. Cl. 222/1; 222/160; 222/161

(57) ABSTRACT

A viscous fluid dispensing system and method of dispensing which includes a container mounted on a vibrating support. The container is normally the container from a blender in which a smoothie has been prepared. A motor drives an unbalanced weight which vibrates the container support. This fluidizes the viscous fluid in the container. The container, and the container support are pivoted. The vibration generating means continues to operate while the container is pivoted in order to provide for the uniform dispensing of the viscous fluid from the container.

### FIELD OF THE INVENTION

The preparation of various drinks from fresh fruits or vegetables normally result in a thick and highly viscous fluid which is difficult to dispense or pour from a container into a glass. A similar result occurs when a drink is prepared using frozen ingredients. Prior art devices have been developed to prepare these drinks but nothing is available to assist in pouring the drink from the preparation container in to a glass or beverage container.

### BACKGROUND OF THE INVENTION

Mechanical drink mixers have been in use for a long time. The majority of them are devices which will mix or shake a container into which the ingredients for a drink have been placed. The container is then removed from the device and the drink is poured into a glass. This has not been a problem when the ingredients are liquids. However, recently smoothies and other frozen drinks have gained in popularity. The smoothies are made from ice, frozen yogurt, and/or sorbet and can also include fruit, berries, fruit juice, vitamins, etc. After these ingredients are combined in a blender the resulting product is a thick, viscous fluid. As a result, a smoothie is difficult to pour from the blender into a glass. It tends to flow in a large mass rather than in a thin stream. The open top of a blender is substantially larger than the open top of a glass or cup. Thus it is a common problem for the contents of the blender to be dispensed outside of the glass creating a mess to clean up and wasting the contents of the drink.

### DESCRIPTION OF THE PRIOR ART

U.S. Pat. No. 2,146,860 discloses one of the early beverage shakers. The beverage container 6,7 is held by a pair of clamping jaws 4 & 5. A rotary electric motor 8 is connected to crank 10 through a reduction gear. The crank is connected to slides 23 & 23 which in turn impart a vertical vibration to the beverage container. A timer determines how long the device will operate. After the beverage is finished mixing the beverage container is removed from clamping jaws 4 & 5 and the beverage is poured from the container. This shaker can only be employed with beverages made from low viscous fluids such as water or the like. In addition, there is no provision to fluidize a highly viscous fluid.

U.S. Pat. No. 2,597,536 discloses another type of beverage mixer of shaker. Container 21 is held in yoke 19 by pin 24′. An electric motor operates a toothed arm 15 through a series of belts and pulleys. The toothed arm oscillates back and forth about shaft 13. This arm in turn oscillates shaft 16 back and forth which in turn oscillates master lever 18 and yoke 19. As a result the beverage in container is mixed. The device must be stopped and the container removed from yoke 19 before the beverage can be poured from the container. The device also fails to provide a means to fluidize a highly viscous fluid and therefore can only be used with low viscous fluids such as water or the like.

### SUMMARY OF THE INVENTION

This device is adapted to receive the blending container of a blender in which a smoothie or similar drink has been prepared. The container is placed in a V-shaped support to which vibrations are imparted. These vibrations tend to fluidize the highly viscous drink in the container. In addition, the support is pivoted so as to permit the contents of the container to be easily poured out or dispensed. The vibration producing means is arranged to vibrate one end of the container more than the other end. As a result, the contents of the container are dispensed from the end which is subjected to the lesser amount of vibrations and therefore are readily dispensed and directed into a glass without any spillage.

Accordingly, it is a primary objective of the instant invention to provide a device which will enable a smoothie or similar drink to be easily and evenly dispensed from the container in which it was prepared.

It is a further objective of the instant invention to provide a device which will fluidize a highly viscous mixture to allow it to be dispensed from a container in such a manner that the person dispensing the mixture can easily vary the amount according to the size of the container into which it is being dispensed.

It is yet another objective of the instant invention to provide a device which is easy to operate.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a front perspective view of the device constructed in accordance with the teachings of this invention.

FIG. 2 is a side elevational view of the device.

FIG. 3 is a front elevational view of the device.

FIG. 4 is a top view of the device.

FIG. 5 is a side sectional view of the device taken along line 5-5 in FIG. 4.

### DETAILED DESCRIPTION OF THE INVENTION

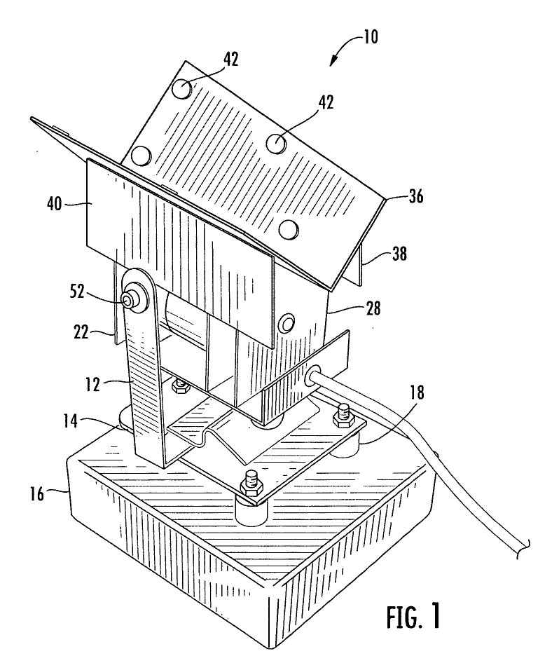

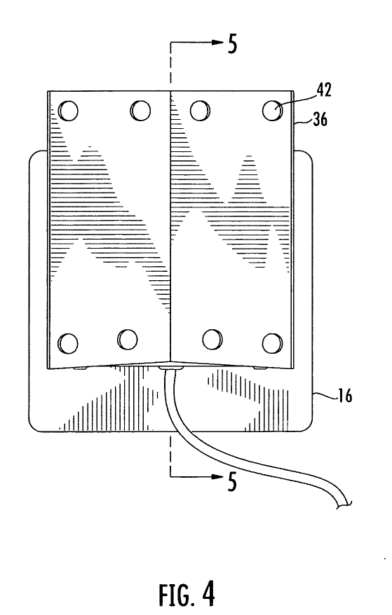

FIGS. 1-5 show a mixing and dispensing device 10. In a preferred albeit non-limiting embodiment, as shown in FIG. 1, the dispensing device 10 generally comprises a U-shaped support 12 attached to a support plate 14. The support plate is resiliently mounted onto a base 16. Base 16 has feet 17 mounted to the bottom thereof. Preferably the feet are resilient suction cups so as to enable the device to remain securely attached to the surface on which it is placed. These feet will also prevent the device from “walking” during operation. Other types of feet 17 may also be employed such as solid rubber feet and rubber feet attached to springs which in turn are attached to the base. Rubber bushings 18 mount the support plate 14 onto the base 16. Other resilient materials could be used in place of rubber for the supports 18. Pivotally attached to the supports 12 is a housing which contains the vibration generation means and the open top fluid container retention means 36.

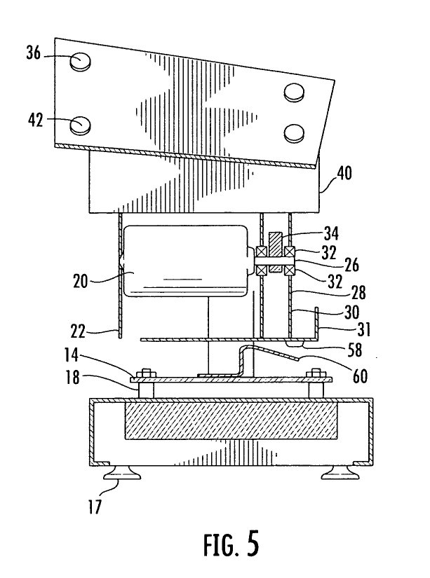

The preferred means to generate the vibrations comprise an electric motor 20, FIG. 5, which is mounted to a front end wall 22. The other end of motor 20 contains the output shaft 26. The output shaft passes through an intermediate wall 30 and a rear end wall 28. The output shaft is supported by a set of bearings 32 mounted on rear end wall 28 and intermediate wall 30. Intermediate the bearings 32 a weight 34 is eccentrically mounted on the output shaft 26. The rotation of this weight by the electric motor produces the vibrations. The intermediate wall 30 and rear end wall 28 are connected to a bottom wall 31 at their lower ends. Other means to generate vibrations include, but are not limited to, electric solenoids, tappers, etc.

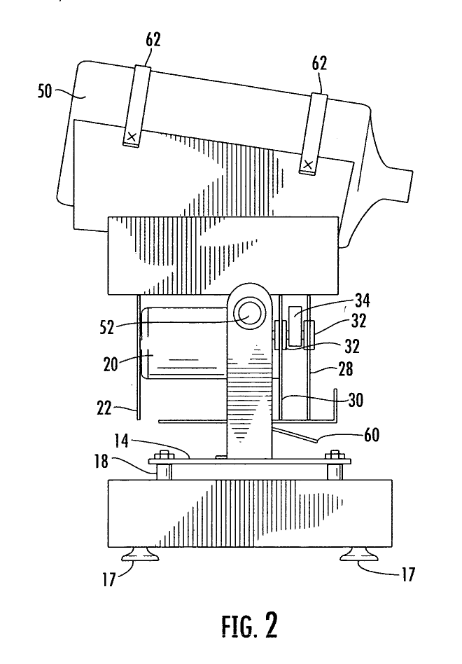

A V-shaped container support or retention means 36 is mounted on top of end walls 22, 28 and intermediate wall 30. Side support walls 38 and 40 are securely attached to container retention means 36, end walls 22, 28 and intermediate wall 30 by means of welds or similar attachment means. Supports 42 are located on container retention means 36 to provide resilient support for a beverage container 50 placed on container retention means 36. Supports are made from a resilient material which will also frictionally engage and hold a beverage container on support 36. A preferred resilient material is rubber, however other materials with similar properties could also be employed. A container for a beverage 50 rests on supports 42. Alternatively, straps 62 can be employed to releasably retain the container, as shown in FIG. 2. They are attached to the container retention means 36 and encompass the container 50. Additional alternative retention means include, but are not limited to, belts, bands, and a housing which encompasses the container. These are attached to the container retention means 36 and encompass the container. Another type of retention means comprise tabs located on the container 50 which cooperate with clips positioned on the retention means 36.

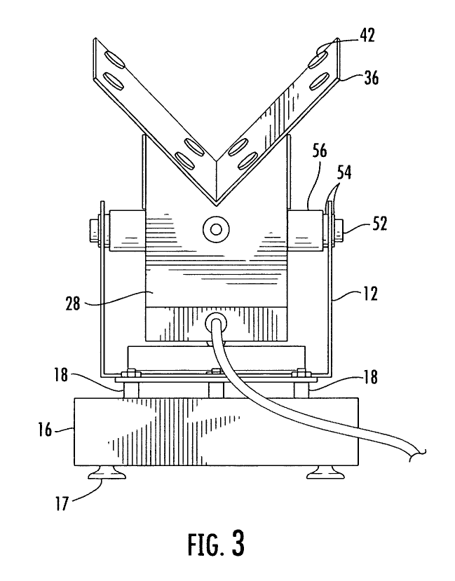

The means to pivotally attach the housing to the supports 12 comprise threaded fasteners 52, FIG. 3. Although other types of fasteners could be employed. One end of the fastener is pivotally mounted onto support 12. Friction reducing washers 54 are placed on fastener 52 on both sides of support 12. A rubber bushing 56 is located between one of the side support walls 38, 40 and a friction reducing washer 54. A nut (not shown) is employed to tightly secure the fastener 52 to the side support. When assembled the side support, fastener, rubber bushing and washers together pivot as a unit with respect to the supports 12. Stops 58 are attached to the bottom wall 31 and abut against stop member 60 mounted on support plate 14. This limits the pivotal movement of the device in one direction.

In the preferred embodiment illustrated, the motor 20 is activated and in turn spins output shaft 26. Unbalanced weight 34, mounted on shaft, rotates about the shaft and imparts a vibration to the motor and everything rigidly connected thereto. This includes end walls 22, 28, intermediate wall 40, side support walls 38, 40, V-shaped container support 36 and beverage container 50. As a result of the electric motor being mounted toward one end of the container support, this end vibrates substantially less than the opposite end. When the beverage container 50 is placed in the container support the open end of the container, from which the beverage is to be dispensed, should be placed at the end of the container support above the electric motor. The motor and unbalanced weight continue to rotate while the beverage container is pivoted for dispensing the beverage. In this manner the beverage can be dispensed from the container in a uniform flow, without being thrown around, as a result of the device vibrating less at this end. The opposite end of the beverage container will be subjected to a substantially greater vibration which is sufficient to keep the beverage in a fluidized state to allow for it to be easily dispensed from the container. During normal operation of the device the longitudinal axis of the container support 36 is inclined with respect to a horizontal plane passing through fasteners 52. This inclination helps maintain the beverage in the container until the user pivots the container support 36 about the axis of fasteners 52. This pivoting tilts the open end of the beverage container downwardly so that the contents may be poured out into a glass.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A viscous fluid dispensing system comprising:
an open top container adapted to contain a viscous fluid;
a vibratory assembly including a container retention means having a longitudinal axis, said container retention means adapted to releasably retain said open top container and is pivotable transverse to said longitudinal axis for dispensing of a viscous fluid from said open top container, and vibration imparting means in mechanical engagement with said container retention means for imparting vibratory motion thereto; and
resilient mounting means in mechanical engagement with said vibratory assembly;
whereby selective dispensing of a viscous fluid is enabled.

2. The viscous fluid dispensing system of claim 1 wherein said vibration imparting means is rigidly connected to said container retention means.

3. The viscous fluid dispensing system of claim 1 wherein said vibration imparting means comprises an electric motor positioned below said container retention means and a weight eccentrically mounted on an output shaft of said electric motor whereby a vibratory motion is imparted to said container retention means.

4. The viscous fluid dispensing system of claim 1 wherein said vibration imparting means produces a non-uniform degree of vibration along the longitudinal axis of said vibratory assembly.

5. The viscous fluid dispensing system of claim 1 wherein said means to releasably retain said open top container further include a plurality of elements mounted on said container retention means which frictionally engage said open top container.

6. The viscous fluid dispensing system of claim 1 wherein said means to releasably retain said open top container further include means attached to said container retention means for releasably engaging said open top container.

7. The viscous fluid dispensing system of claim 1 further including support structure constructed and arranged for pivotal engagement with said vibratory assembly;
said support structure including at least one member pivotably engaged with said vibratory assembly.

8. A method of dispensing a viscous fluid comprising:
providing an open top container;
filling said open top container with a viscous fluid;
positioning said open top container which contains said viscous fluid in a container retention means;
imparting a vibration to said container retention means and said open top container;
pivoting said container retention means to a position effective for dispensing said viscous fluid; and
dispensing said viscous fluid from said open top container into another container.
